(19) United States
(12) Patent Application Publication
(10) Pub. No.: US 2026/0276412 A1
(43) Pub. Date: Sep. 17, 2026

(54) High-Sensitivity Forward-Transmission Vibration Sensing for Real-World Urban Fiber Infrastructure

(71) Applicant: NEC Laboratories America, Inc., Princeton, NJ (US)

(72) Inventors: Jian Fang, Princeton, NJ (US); Ming-Fang Huang, Princeton, NJ (US); Ting Wang, West Wundsor, NJ (US)

(21) Appl. No.: 19/567,115

(22) Filed: Mar. 14, 2026

Related U.S. Application Data
(60) Provisional application No. 63/771,626, filed on Mar. 14, 2025.

(51) Int. Cl. G01D 5/353; G01H 9/00

(52) U.S. Cl. CPC G01D 5/35351; G01H 9/004

(57) ABSTRACT

A high-sensitivity forward-transmission vibration sensing system and method for urban fiber infrastructure. The system utilizes adaptive time-frequency (T-F) masking to identify weak vibration events by suppressing common laser phase noise in the time-frequency domain. Accurate localization is achieved through in-band laser phase noise suppression using a detuning matrix to balance correlation terms. The invention enables detection and localization of real-world events, such as footsteps and construction activity, in noisy metropolitan environments where conventional filtering fails.

### CROSS REFERENCE TO RELATED APPLICATIONS

This application claims the benefit of U.S. Provisional Patent Application Ser. No. 63/771,626 filed Mar. 14, 2025, the entire contents of which is incorporated by reference as if set forth at length herein.

### FIELD OF THE INVENTION

The present invention relates generally to Distributed Fiber Optic Sensing (DFOS) technology. More particularly, the invention relates to distributed vibration sensing (DVS) using forward-transmission in metropolitan fiber optic networks.

### BACKGROUND OF THE INVENTION

Distributed vibration sensing (DVS) using optical fiber infrastructure has emerged as a promising technology for applications including traffic monitoring and intrusion detection. Of particular interest, forward-transmission-based vibration sensing potentially offers key advantages over backscattering-based sensors and techniques, such as broader sensing bandwidth, higher signal-to-noise ratio (SNR), extended sensing range, and compatibility with unidirectional amplification. Notwithstanding such promise, conventional approaches use bandpass filters (BPFs), which require prior knowledge of events and often fail when weak vibration signals overlap with the laser phase noise bandwidth.

### SUMMARY OF THE INVENTION

The above problem is solved and an advance in the art is made according to aspects of the present invention directed to a system and method that provides a high-sensitivity forward-transmission vibration sensing system enhanced by adaptive time-frequency (T-F) masking and in-band laser phase noise suppression.

In sharp contrast to the prior art, our inventive system utilizes a narrow linewidth laser (NLL) and

a loop configuration to probe counter-propagating fibers within a deployed cable. The system implements an adaptive T-F masking method that transforms receiver (Rx) phases into the time-frequency domain via Short-Time Fourier Transform (STFT) and subtracts them to suppress common phase noise. This allows for the identification of weak vibration events without prior knowledge.

Advantageously, our inventive system and method introduces in-band laser phase noise suppression using a detuning matrix to balance correlation terms, enabling accurate event localization even for weak signals with amplitude as low as 10 rad submerged in noise.

### BRIEF DESCRIPTION OF THE DRAWING

FIG. 1(A) and FIG. 1(B) are schematic diagrams showing an illustrative prior art uncoded and coded DFOS systems.

FIG. 2 is a schematic flow diagram showing an illustrative overall operation of systems and methods according to aspects of the present invention.

FIG. 3 is a schematic diagram showing an illustrative overall forward transmission vibration sensing system in an urban fiber infrastructure according to aspects of the present invention.

FIG. 4 is a schematic diagram showing illustrative Rx phase demodulation according to aspects of the present invention.

FIG. 5 is a schematic diagram showing an illustrative adaptive T-F masking and in-band noise suppression according to aspects of the present invention.

FIG. 6(A) is a schematic map diagram showing illustrative experimental field fiber layout in Dallas, Texas according to aspects of the present invention.

FIG. 6(B) is a schematic diagram showing illustrative experimental setup with DSP steps in which NLL is a narrow linewidth laser, PMBS is a polarization maintaining beam splitter, SOM is an acousto-optic modulator, PC is a polarization controller, ICR is an integrated coherent receiver, DSO is digital signal oscilloscope, DAS is distributed acoustic sensor, TX is a transmitter, and Rx is a receiver, according to aspects of the present invention.

FIG. 6(C) is a schematic of an illustrative DAS waterfall data plot of field fiber according to aspects of the present invention.

FIG. 6(D) is a schematic of an illustrative data plot of raw Rx phases after demodulation according to aspects of the present invention.

FIG. 7(A), FIG. 7(B), FIG. 7(C), FIG. 7(D), FIG. 7(E), FIG. 7(F), FIG. 7(G), and FIG. 7(H) show: FIG. 7(A) spectrum of Rx1 phase, FIG. 7(B) spectrogram after subtraction, FIG. 7(C) the t-f masking matrix, FIG. 7(D) phase after BPFs and our inventive method, FIG. 7(E) correlogram by GCC-PHAT with masking, FIG. 7(F) correlogram with masking and in-band laser noise suppression, FIG. 7(G) comparison of different localization method where dashed line is DAS ground truth (GT), and FIG. 7(H) measured data from DAS as a reference, according to aspects of the present invention.

FIG. 8(A), FIG. 8(B), FIG. 8(C), FIG. 8(D), FIG. 8(E), FIG. 8(F), FIG. 8(G), and FIG. 8(H) show detection and localization of more events including: FIG. 8(A), FIG. 8(B), FIG. 8(C), and FIG. 8(D) for pole impact, FIG. 8(E) and FIG. 8(F) for footsteps on handhole lid, FIG. 8(G) and FIG. 8(H) for hitting the cable in handhole, wherein dashed lines in FIG. 8(D), FIG. 8(F), and FIG. 8(H) are DAS ground truth (GT), according to aspects of the present invention.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing (DFOS) systems convert an optical fiber to an array of sensors distributed along the length of the optical fiber. In effect, the optical fiber becomes the array of sensos, while an interrogator generates/injects laser light energy into the optical fiber and senses/detects events along the optical fiber length from backscattered light.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

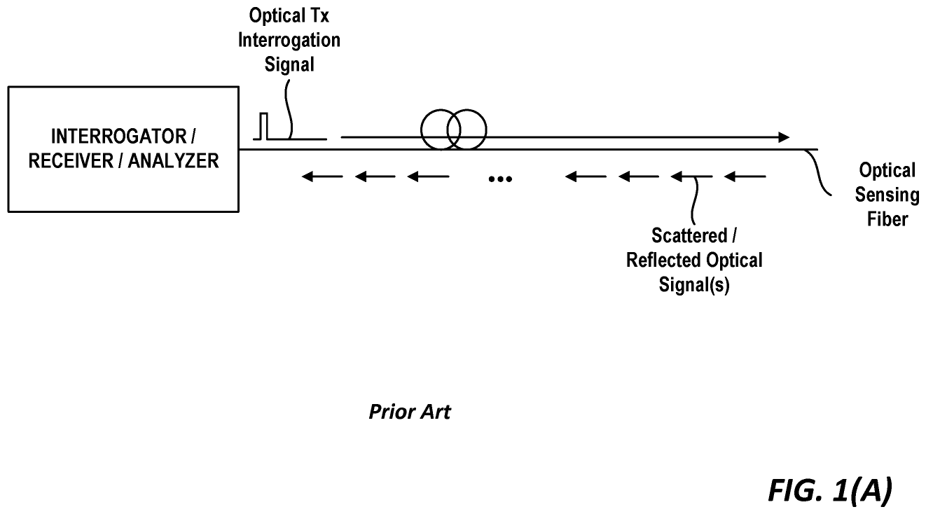

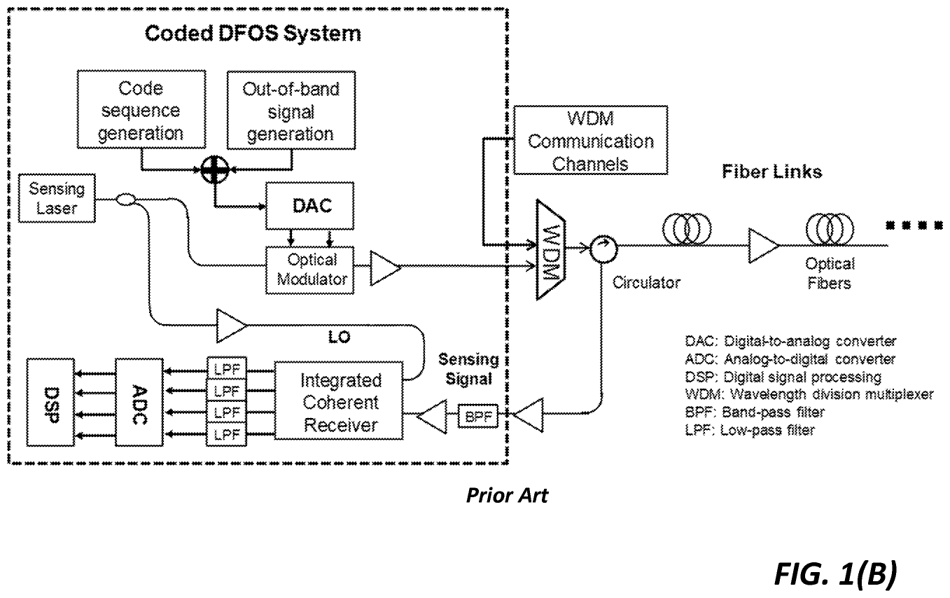

A schematic diagram illustrating the generalized arrangement and operation of a distributed fiber optic sensing system that may advantageously include artificial intelligence/machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detects and/or analyzes reflected and/or backscattered and subsequently received signal(s). The received signals are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DAS/DVS allows continuous monitoring over long distances, but instead of measuring temperature, it measures vibrations and sounds along the fiber.

DAS/DVS operates as follows. Light pulses are sent through the fiber optic sensor cable. As the light travels through the cable, vibrations and sounds cause the fiber to stretch and contract slightly. These tiny changes in the fiber's length affect how the light interacts with the material, causing a shift in the backscattered light's frequency. By analyzing the frequency shift of the backscattered light, the DAS/DVS system can determine the location and intensity of the vibrations or sounds along the fiber optic cable.

DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DAS/DVS technologies have proven useful in a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

As we have noted distributed vibration sensing (DVS) using optical fiber infrastructure has emerged as a promising technology for a wide range of applications, including traffic monitoring, and intrusion detection. Forward-transmission-based vibration sensing has gained increasing attention due to several key advantages over backscattering-based sensors such as broader sensing bandwidth, higher signal-to-noise ratio (SNR), extended sensing range, and compatibility with unidirectional amplification. While the performance of forwarding-transmission vibration sensing has been explored in laboratory settings (See, e.g, Y. Yan, F. N. Khan, B. Zhou, A. P. T. Lau, C. Lu, and C. Guo, “Forward Transmission Based Ultra-Long Distributed Vibration Sensing With Wide Frequency Response,” J. Lightwave Technol. 39, 2241-2249 (2021); and X. Rao, S. Dai, M. Chen, R. Zhu, D. Lu, G. Y. Chen, and Y. Wang, “Multi-point vibration positioning method for long-distance transmission distributed vibration sensing,” Opt. Express 32, 30775 (2024).), field trials have been preliminarily conducted in relatively quiet environments. (See, e.g., G. Wang, Z. Pang, B. Zhang, F. Wang, Y. Chen, H. Dai, B. Wang, and L. Wang, “Time shifting deviation method enhanced laser interferometry: ultrahigh precision localizing of traffic vibration using an urban fiber link,” Photonics Res. 10, 433 (2022)) demonstrated traffic vibration localization along a 31.43-km relatively fiber link plus a 10-km fiber spool in Beijing, though the detected vibrations primarily originated from a single underpass with minimal disturbance along the rest of the link.

I. D. Luch, P. Boffi, M. Ferrario, G. Rizzelli, R. Gaudino, and M. Martinelli, in an article entitled “Vibration sensing for deployed metropolitan fiber infrastructure,” that appeared in J. Lightwave Technol. 39, 1204-1211 (2021), explored the use of 32-km deployed metropolitan fiber in Turin, capturing impulsive events manually induced by PZT and hitting the floor outside the lab.

Y. Yan, L. Lu, X. Wu, J. Wang, Y. He, D. Chen, C. Lu, A. Pak, and T. Lau, in an article entitled “Simultaneous communications and vibration sensing over a single 100-km deployed fiber link by fiber interferometry,” that appeared in Optical Fiber Communication Conference (OFC) 2023 (Optica Publishing Group, 2023), p. W1J.4, demonstrates the vibration sensing with data transmission over 100-km field fiber link in Hong Kong, where vibrations were emulated by PZT under controlled conditions.

E. Ip, Y.-K. Huang, G. Wellbrock, T. Xia, M.-F. Huang, T. Wang, and Y. Aono, in an article entitled “Vibration detection and localization using modified digital coherent telecom transponders,” that appeared in J. Lightwave Technol. 40, 1472-1482 (2022), reported a field trial of forwarding sensing over 380-km field fiber in New Jersey using modified transponders, localizing the strong events such as pole strikes with hammer, fiber tampering, and jackhammer activities on concrete.

In an advance of the art, we disclose herein a high-sensitivity forwarding-transmission vibration sensing system enhanced by adaptive time-frequency (T-F) masking and in-band laser phase noise suppression. Such a system has superior sensitivity over all the existing forwarding-transmission vibration system and can detect real-world weak vibration event even under a noisy urban fiber link with significant vibration interference from road traffic flows and aerial cables. Particularly inventive features include at least the following: i) an architecture of a forwarding-transmission vibration sensing system, ii) an event identification method using our proposed adaptive T-F masking, and iii) an event localization method using our proposed in-band phase noise suppression.

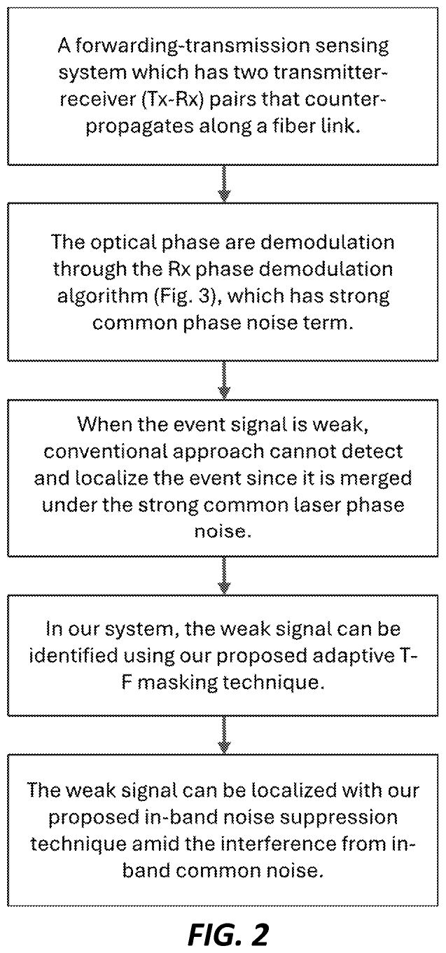

FIG. 2 is a schematic flow diagram showing an illustrative overall operation of systems and methods according to aspects of the present invention.

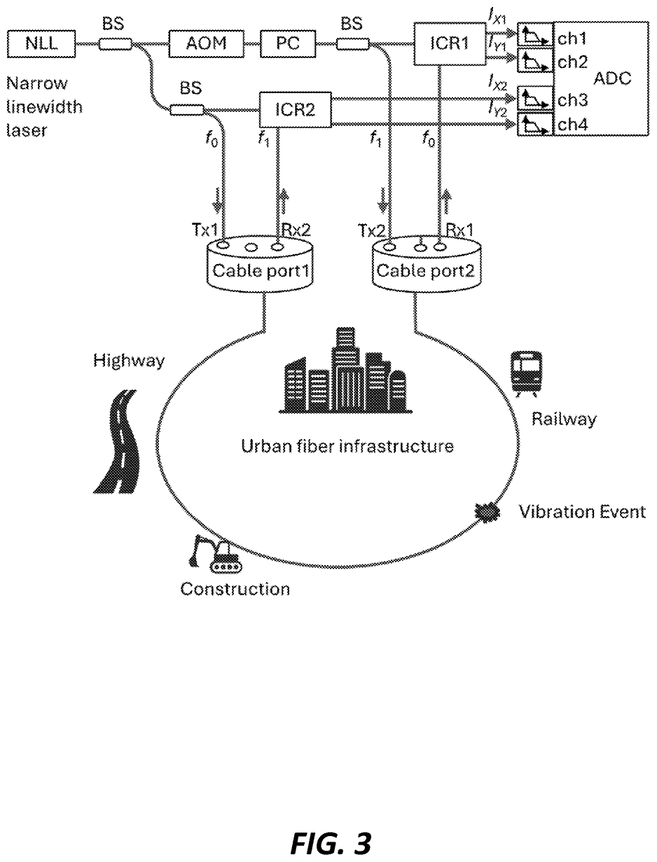

FIG. 3 is a schematic diagram showing an illustrative overall forward transmission vibration sensing system in an urban fiber infrastructure according to aspects of the present invention.

As illustrated, FIG. 3 shows the configuration of a forward-transmission vibration sensing system, including a narrow linewidth laser (NLL), beamsplitters (BS), acousto-optic modulator (AOM), polarization controller (PC), integrated coherent receiver (ICR), low-pass filters (LPF), and analogue-to-digital converters (ADCs). The NLL is split into two branches, which the upper branch frequency-shifted by an AOM. Each branch is further divided into two paths serving as the probe for transmitter (Tx) and LO for receiver (Rx). The Tx probes counter-propagate through two fibers in the same deployed cable. On the Rx side, two ICRs are employed, followed by the LPFs to remove undesired noise. The outputs of ICRs are captured by a 4-channel ADC device.

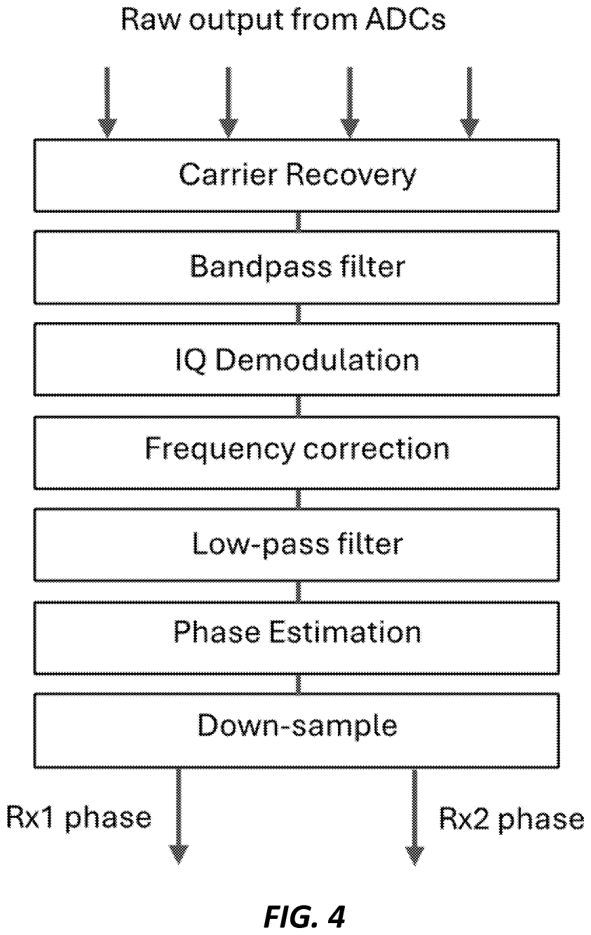

FIG. 4 is a schematic diagram showing illustrative Rx phase demodulation according to aspects of the present invention.

Due to the loop configuration and the use of the same laser source for both Txs, the Rx phases can be expressed as:

$${ϕ}_{R 1} ( t ) = {ϕ}_{PN} ( t ) - {ϕ}_{PN} ( t - {τ}_{L} ) + {ϕ}_{v} ( t - {τ}_{1} ) + {ϕ}_{n 1} ( t )$$

$${ϕ}_{R 2} ( t ) = {ϕ}_{PN} ( t ) - {ϕ}_{PN} ( t - {τ}_{L} ) + {ϕ}_{v} ( t - {τ}_{2} ) + {ϕ}_{n 2} ( t )$$

where φ_{PN}(t) is the laser phase noise, τ_{L} is the time delay of the entire fiber, φᵥ is the vibration event. τ₁ and τ₂ are the propagation delays to Rx1 and Rx2, respectively. φₙ₁ and φₙ₂ are the perturbative phase noise accumulated over the entire link.

It is noted that two Rx phases experience the same laser phase drift term Δφ_{PN}(t)=φ_{PN}(t)−φ_{PN}(t−τ_{L}), making it challenging to identify and localize the vibration events when their frequency overlaps with laser phase noise bandwidth. Conventional approaches use bandpass filters (BPFs) which requires prior knowledge of the event. While the BPF can suppress out-of-band noise, the in-band noise may still dominate the cross-correlation (CC), particularly when the event signal is weak.

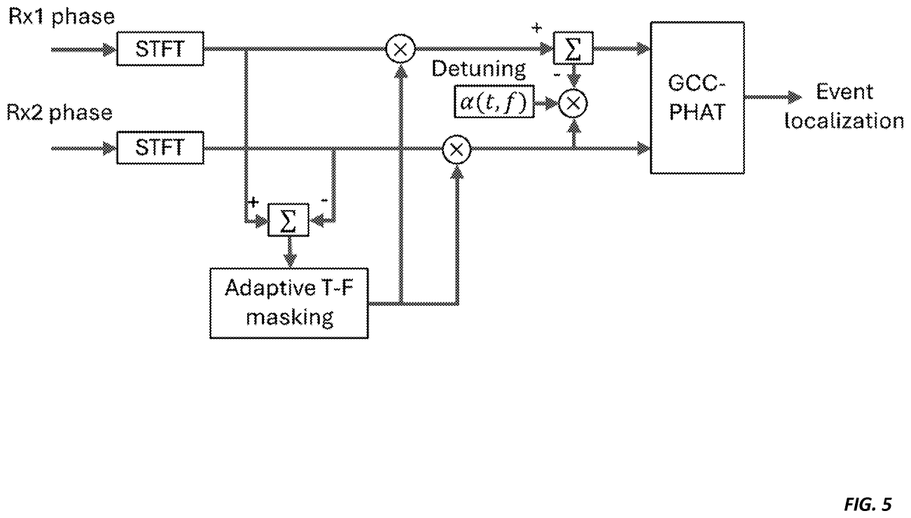

To overcome these limitations, we proposed a novel processing technique powered by (1) adaptive T-F masking for high-sensitivity event identification, ands (2) in-band laser phase noise suppression for accurate localization, as shown in FIG. 5., which is a schematic diagram showing an illustrative adaptive T-F masking and in-band noise suppression according to aspects of the present invention.

The T-F masking is implemented by transforming Rx phases into time-frequency domain via Short-Time Fourier Transform (STFT) as X_{1,2}(t,f), then subtracting them as ΔX(t,f)=X₁(t,f)−X₂(t,f) to suppress the common phase noise term Δφ_{PN}(t). To identify possible events, an adaptive masking method is implemented by scanning the compressed power spectrogram S(t,f)=ln |ΔX(t,f)|₂, updating the threshold ξ(t,f), and selecting T-F points above the threshold to form a binary masking matrix M(t,f). Then both X_{1,2}(t,f) are multiplied by the masking matrix M(t,f) to keep the selected T-F data as

$${X}_{1 , 2}^{′}$$

(t,f). Such techniques can effectively identify the event without prior knowledge and remove most of the out-of-band noise.

The in-band laser phase noise suppression is implemented by introducing a detuning matrix 0≤α(t,f)≤1. The cross correlation is calculated between

$${X}_{1}^{′} ( t , f ) - α ( t , f ) \cdot {X}_{2}^{′} ( t , f ) and {X}_{2}^{′} ( t , f )$$

using generalized cross-correlation with phase transform (GCC-PHAT). Assigning the in-band laser with the detuning term

$${Φ}_{PN}^{′} ( t , f ) ,$$

the key is to balance the correlation term

$$E [ ( 1 - α ( t , f ) ) {Φ}_{PN}^{′} ( t , f ) {Φ}_{PN}^{′ *} ( t , f ) ]$$

with the detuning term

$$E [ - α ( t , f ) {X}_{2}^{′} ( t , f ) {X}_{2}^{′ *} ( t , f ) ]$$

so that the desired correlation term

$$E [ {X}_{1}^{′} ( t , f ) {X}_{2}^{′ *} ( t , f ) ]$$

will be unbiased. Such technique can suppress the interference of in-band laser noise and obtain the correct time delay for weak vibration events.

It is noted that subtraction may reduce the response of events occurring at the center of the fiber route. Such issue can be solved by adding extra fiber length to one Tx polarizations to break the symmetry.

As we have noted, the real-world performance of forwarding-transmission vibration sensing in a dynamic metropolitan network is somewhat uncertain and our field trial answers the following questions: How does it perform under complex road traffic perturbations? How does its sensitivity compare to backscattering-based DAS systems? What types of signals can be reliably detected, and what might go unnoticed? Addressing these open questions, this disclosure presents an experimentally verified, high-sensitivity forwarding sensing system, enhanced by adaptive time-frequency (t-f) masking and in-band phase noise suppression.

Weak real-world events detection and localization across 80-km deployed urban fiber network will be demonstrated, especially under the complex metropolitan environment subject to road traffic induced vibrations and aerial-cable perturbations.

### Experimental Field Trial Layout and Setup

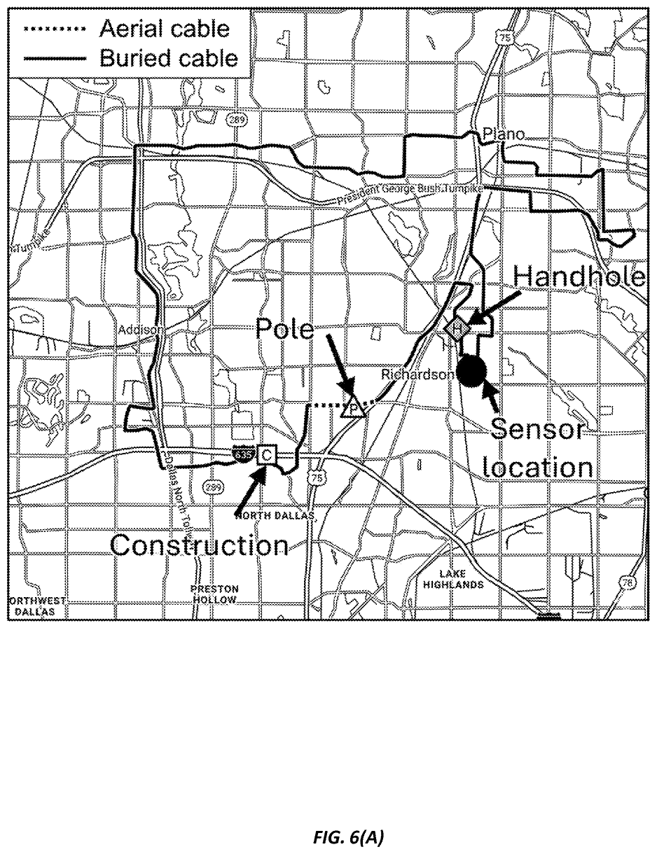

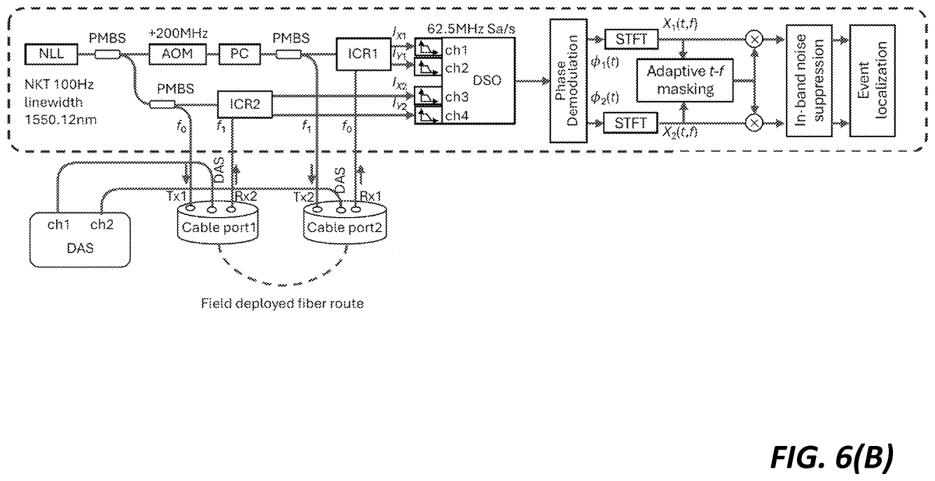

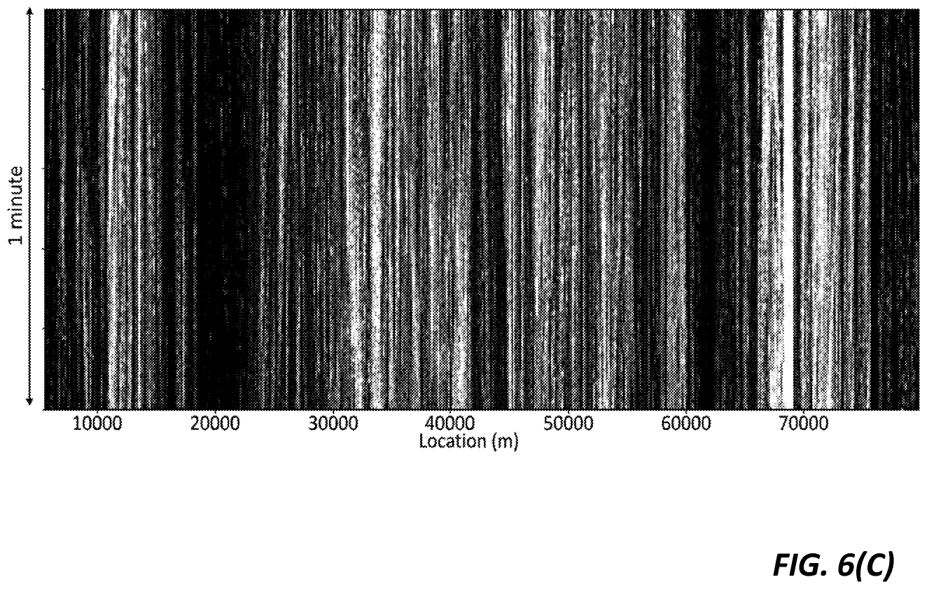

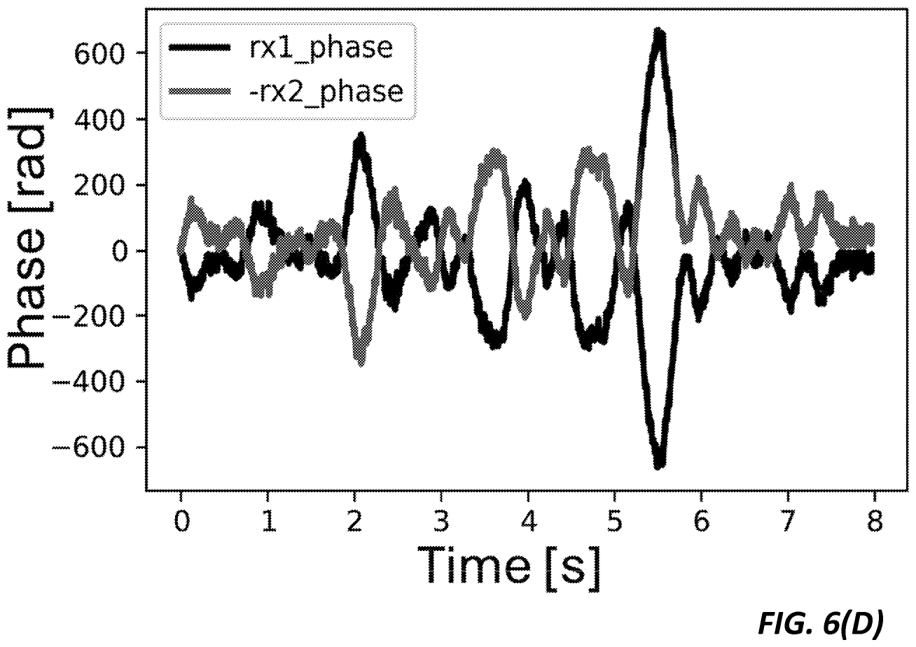

FIG. 6(A) is a schematic map diagram showing illustrative experimental field fiber layout in Dallas, Texas according to aspects of the present invention. As shown, the figure illustrates the deployed fibers used in this trial, consisting of an 80-km SSMF field link from Verizon networks, which includes both buried and aerial cables. The buried cable runs adjacent to service roads of major highways, subject to heavy traffic flows as shown in FIG. 6(C). The aerial cable introduces strong phase perturbations due to the wind.

The experimental setup is shown in FIG. 6(B). A 100-Hz linewidth NLL is split into two branches, which the upper branch frequency-shifted by +200 MHz using an AOM. Each branch is further divided into two paths serving as the probe for Tx and LO for Rx. The Tx probes counter-propagate through two fibers in the same deployed cable, with power set to −2 dBm to prevent nonlinear effects. On the Rx side, two 40 G ICRs are employed, followed by 250 MHz LPFs. The in-phase parts of ICRs I_{X1}, I_{Y1}, I_{X2}, I_{Y2} are captured by a 4-ch DSO with sub-Nyquist sampling at 62.5 MSa/s. The setup is mounted on a breadboard inside a data center with ambient noise level over 85 dBA. A multi-channel DAS system is connected to two other fibers within the same cable as a reference.

### High Sensitivity Forwarding Vibration Sensing and the Field Trial Results

FIG. 6(D) shows the demodulated Rx phases. Due to the loop configuration same NLL for both Txs, the Rx phases can be expressed as φ_{R1,2}(t)=Δφ_{PN}(t)+φᵥ(t−τ_{1,2})+φ_{b1,2}(t), where Δφ_{PN}(t)=φ_{PN}(t)−φ_{PN}(t−τ_{L}) is the NLL phase noise (φ_{PN}) difference to the entire fiber delay τ_{L}, φᵥ is the vibration event, τ_{1,2} are the propagation delays to each Rx. φ_{n1,2} are the perturbative phase noise accumulated over the entire link.

In this setup, two Rx phases experience the same laser phase drift, making it challenging to identify and localize the vibration events when their frequency overlaps with laser phase noise bandwidth. Conventional approaches use bandpass filters (BPFs) which requires prior knowledge of the event. While the BPF can suppress out-of-band noise, the in-band noise may still dominate the cross-correlation (CC), particularly when the event signal is weak. To overcome these limitations, we proposed a novel processing technique powered by (i) adaptive t-f masking for high-sensitivity event identification (ii) in-band laser phase noise suppression for accurate localization. The t-f masking is implemented by transforming Rx phases into t-f domain via STFT as X_{1,2}(t,f), then subtracting them as ΔX=X₁−X₂ to suppress the common phase noise term Δ#₊.

To identify possible events, an adaptive masking method is implemented by scanning the compressed power spectrogram S (t,f)=ln |ΔX|², updating the threshold ξ(t,f), and selecting t-f points above the threshold to form a binary masking matrix M(t,f). Both X_{1,2}(t,f) are multiplied by the masking M to keep the selected t-f data as

$${X}_{1 , 2}^{′} ( t , f ) .$$

Such technique can effectively identify the event without prior knowledge and remove most of the out-of-band noise. The in-band laser phase noise suppression is implemented by introducing a detuning matrix 0≤α(t,f)≤1. The cross correlation is calculated between

$${X}_{1}^{′} - α {X}_{2}^{′} and {X}_{2}^{′} .$$

Denoting the in-band laser phase noise after masking as

$${Φ}_{PN}^{′} ( t , f ) ,$$

the key is to balance the correlation term;

$$E [ ( 1 - α ) {Φ}_{PN}^{′} {Φ}_{PN}^{′ *} ]$$

with the detuning term;

$$E [ - α {X}_{2}^{′} {X}_{2}^{′ *} ]$$

so that the desired correlation term;

$$E [ {X}_{1}^{′} {X}_{2}^{′ *} ]$$

will be unbiased. Such technique can suppress the interference of in-band laser noise and obtain the correct time delay for weak vibration events. It is noted that subtraction may reduce the response of events occurring at the center of the fiber route. Such issue can be solved by adding extra fiber length to one Tx polarization to break the symmetry.

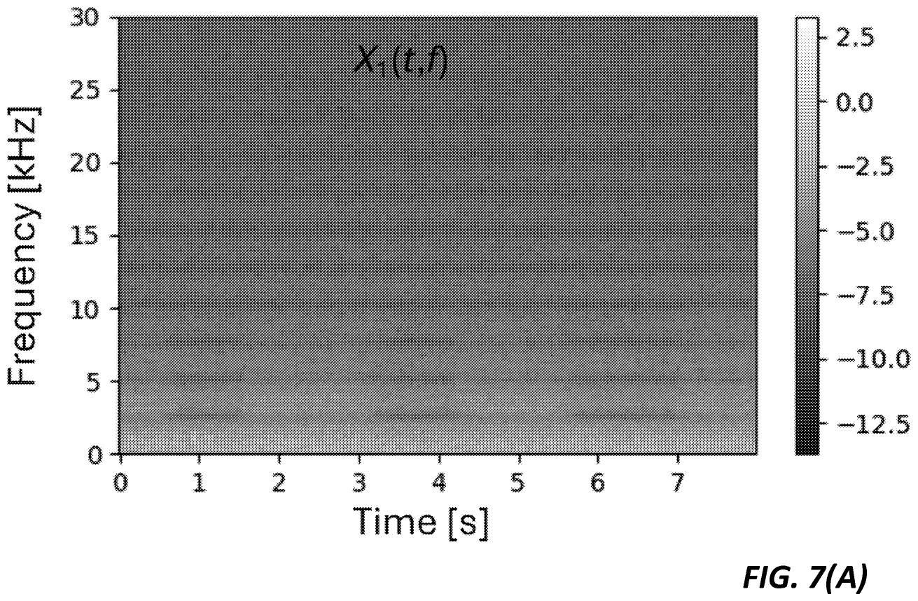

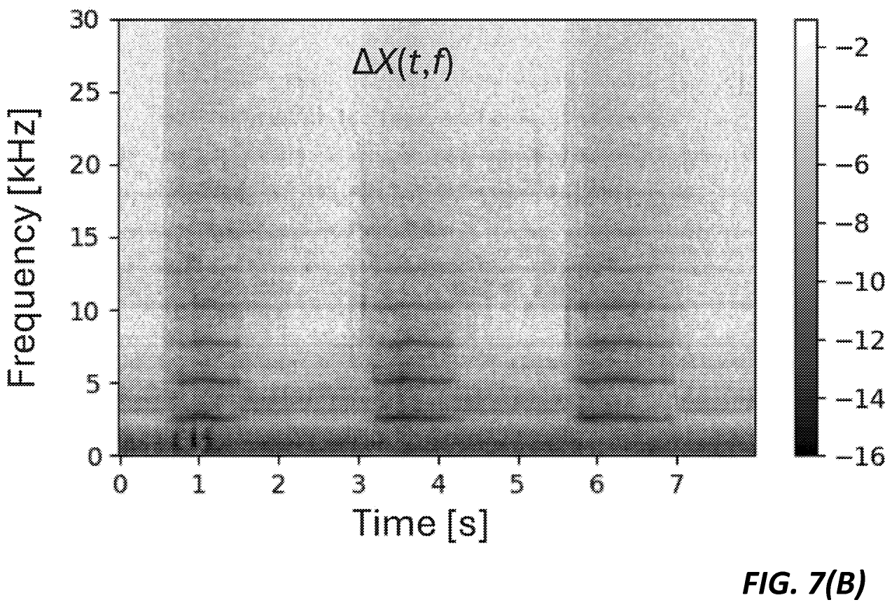

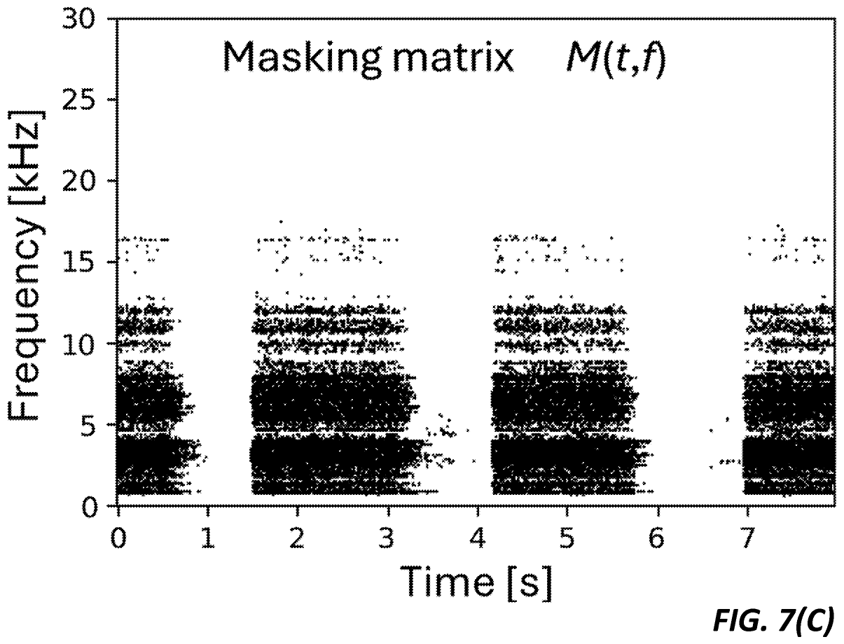

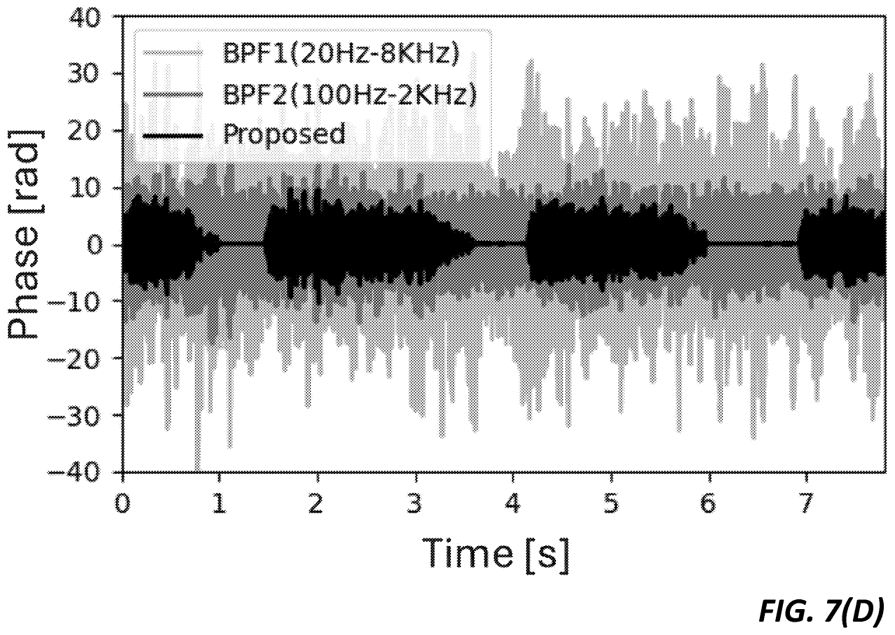

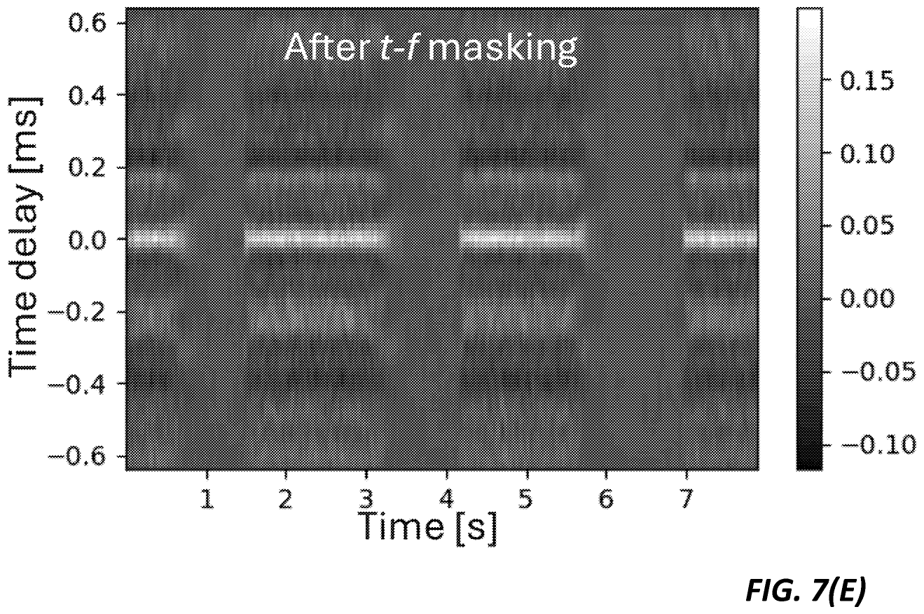

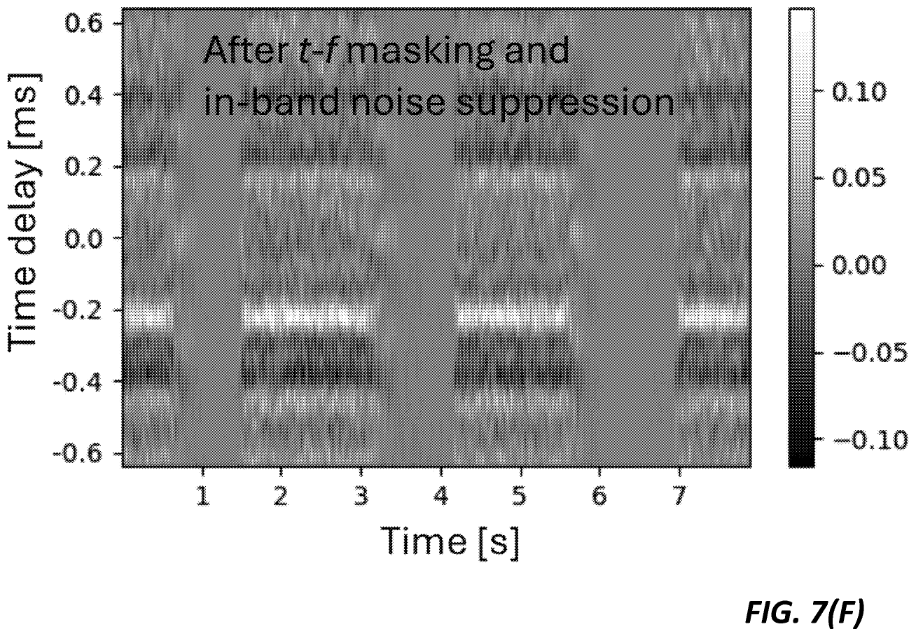

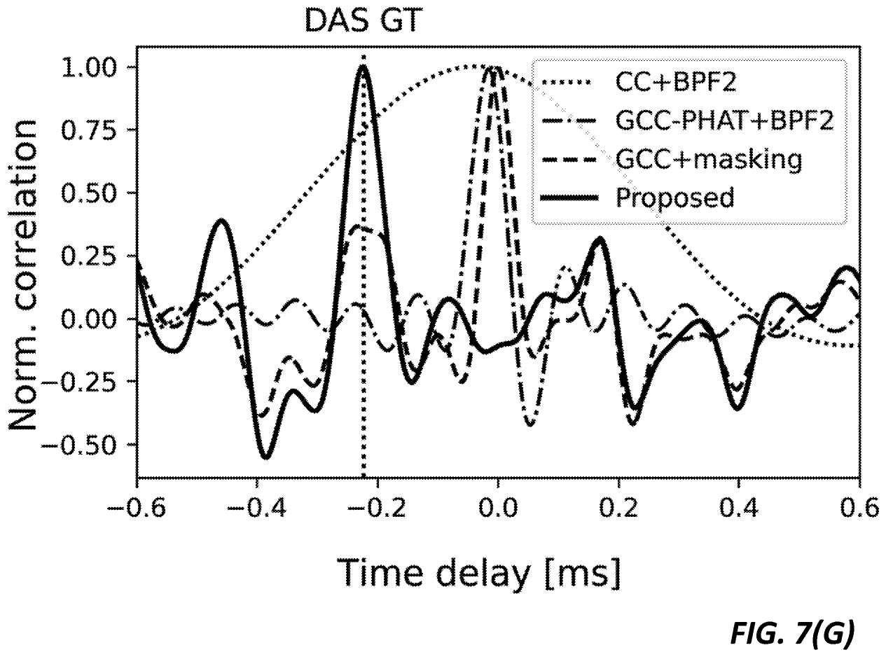

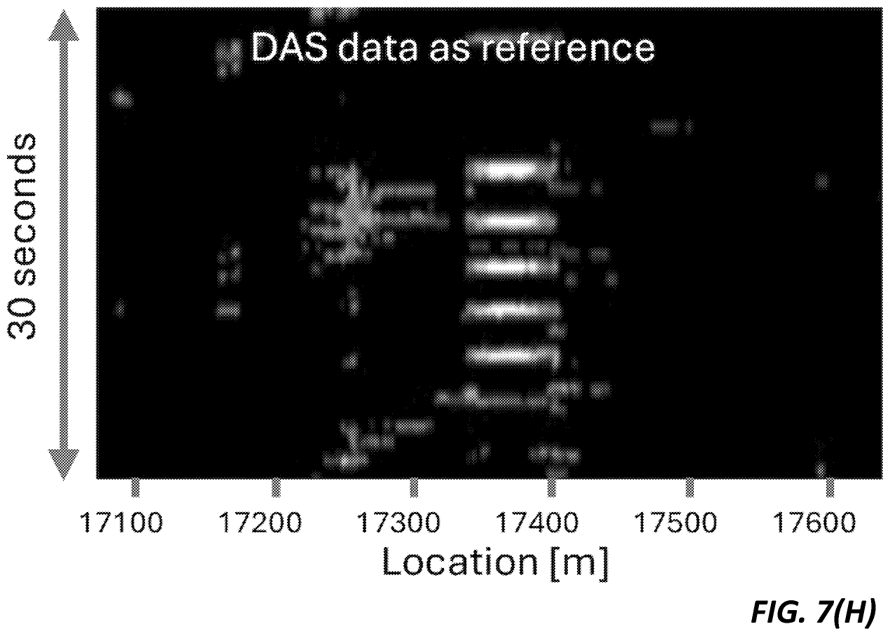

FIG. 7(A)-FIG. 7(H) show a real-world construction event detected by our system in the field fiber. The event pattern is barely visible on the original spectrogram X₁, as shown in FIG. 7(A) but becomes more distinct on the subtracted spectrogram ΔX, shown in FIG. 7(B), enabling the identification of event features and the construction of the masking matrix shown in FIG. 7(C). FIG. 7(D) shows the time-domain waveform (Rx1) after t-f masking, compared to the waveforms processed by conventional BPFs (BPF1: 20 Hz-10 kHz, BPF2: 100 Hz-2 kHz). Due to the small signal amplitude (~20 rad), BPFs struggle to clearly identify the event, whereas the proposed method reveals a distinct and recognizable event signature.

FIG. 7(E) denotes correlogram by generalized cross-correlation with phase transform (GCC-PHAT) with largest correlation peak at zero delay due to in-band phase noise. After applying in-band noise suppression, the correlogram eliminates the ghost peak at zero delay and reveal the correct time shift, as shown in FIG. 7(F).

FIG. 7(G) compares the performance of different localization algorithms. Both CC and GCC-PHAT with BPF fail to localize the construction event, while our proposed method produces a clear correlation peak that aligns well with the DAS ground truth.

FIG. 7(H) shows the measured DAS waterfall confirming construction event at 17,385 m (south) near a manhole. Due to the limited interrogating bandwidth of DAS, (i.e., 625 Hz Nyquist bandwidth for 80 km fiber) the construction signal detected by DAS does not appear stronger than other traffic-induced vibration such as heavy trucks and the trains. However, in forwarding-transmission sensing, road traffic vibrations primarily occupy the low-frequency range (<200 Hz) while the broadband construction dominates the high frequency band, making it distinct from other events based on its high-frequency signatures. This highlights the advantage of wide bandwidth in forwarding sensing for identifying broadband events over long distances.

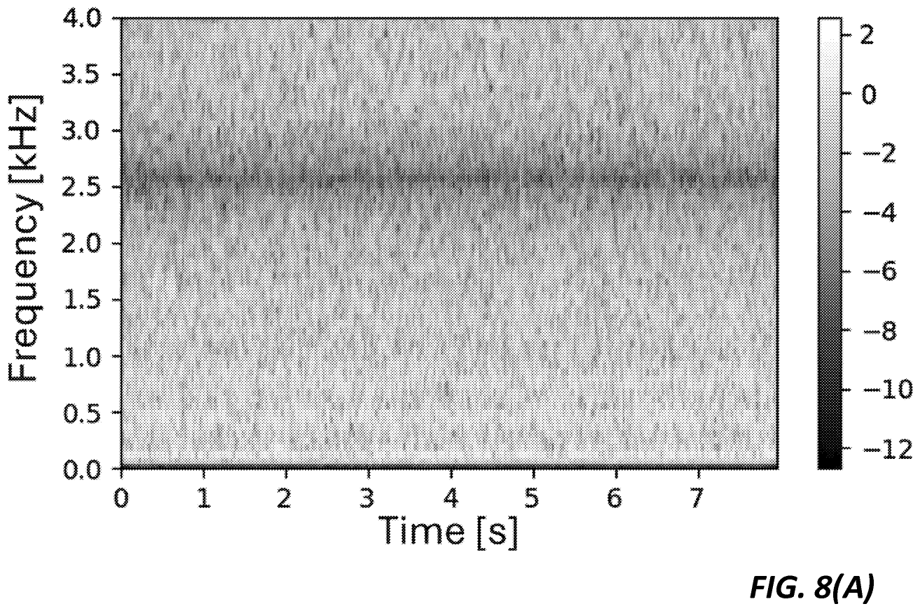

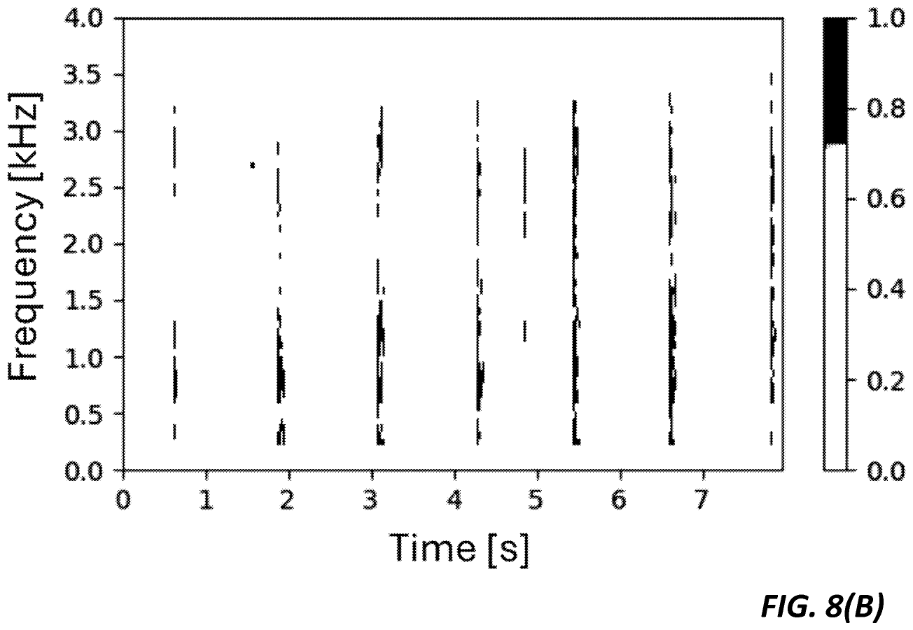

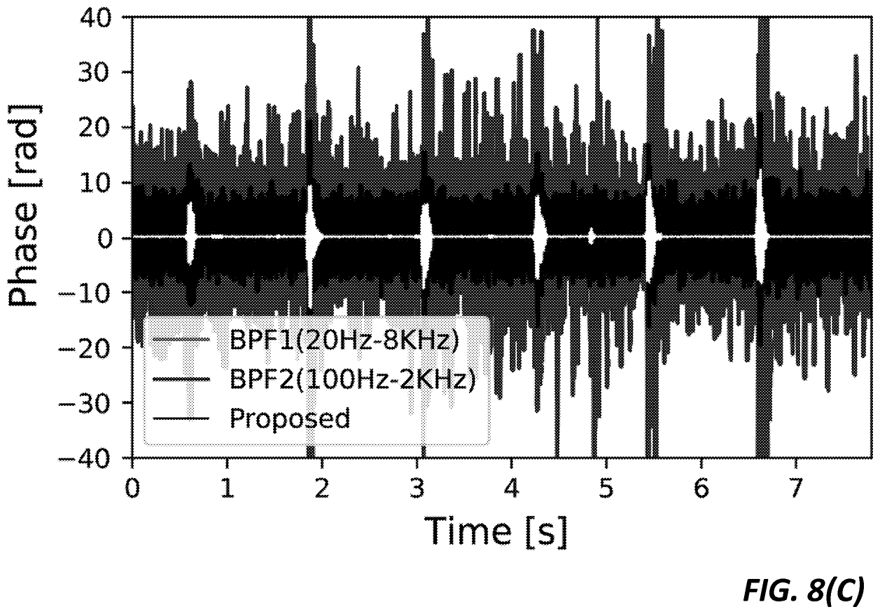

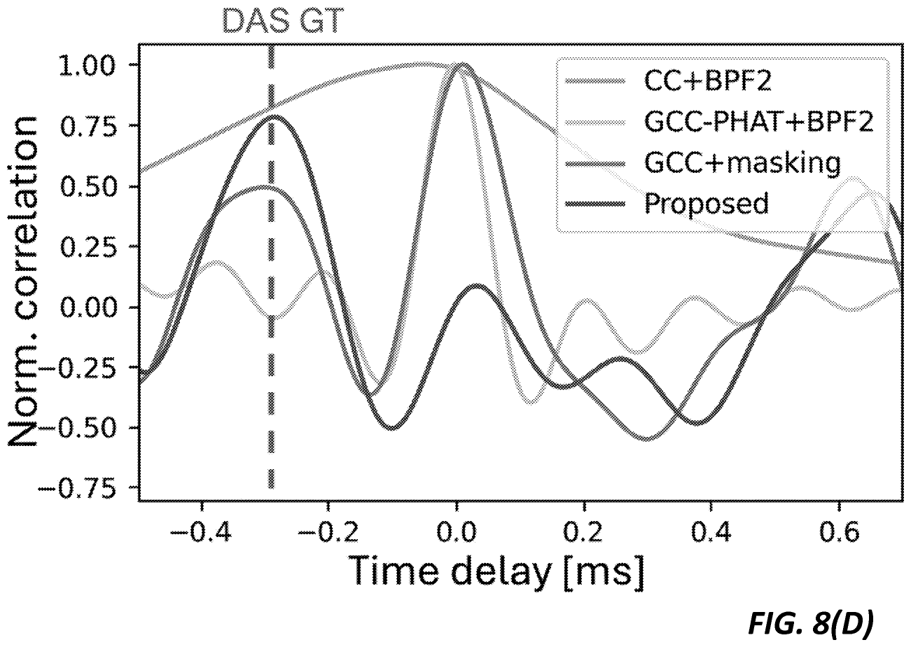

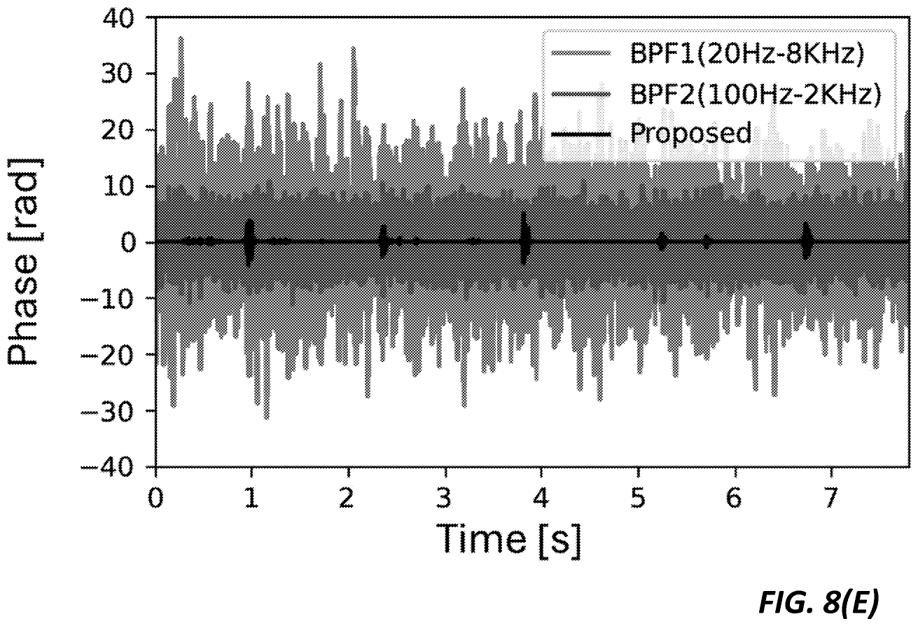

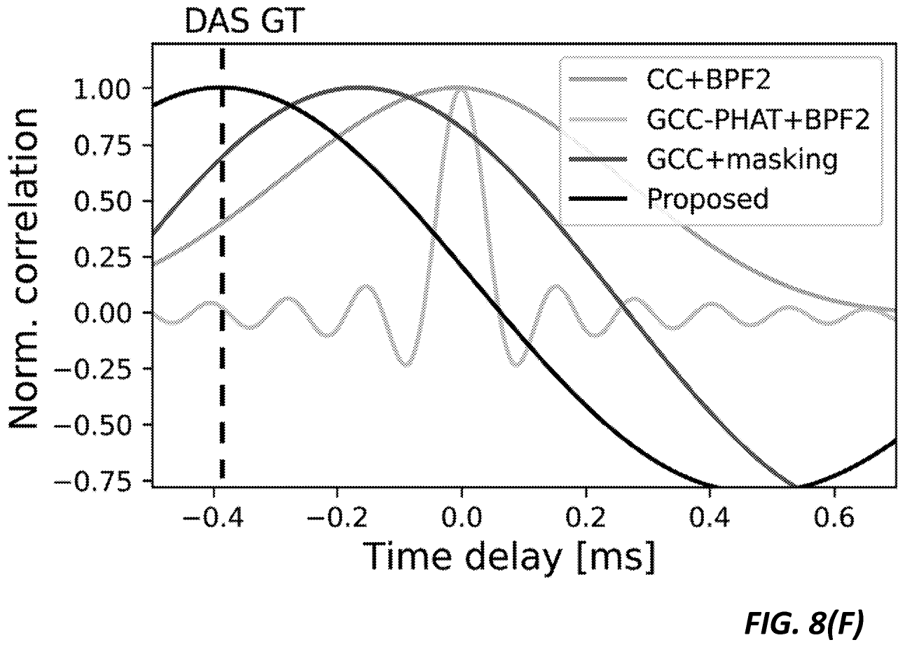

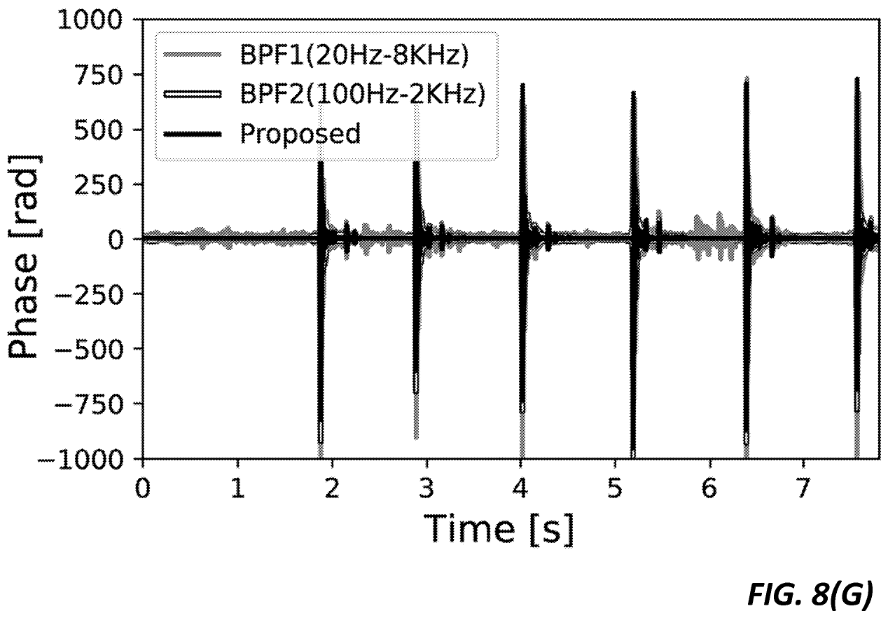

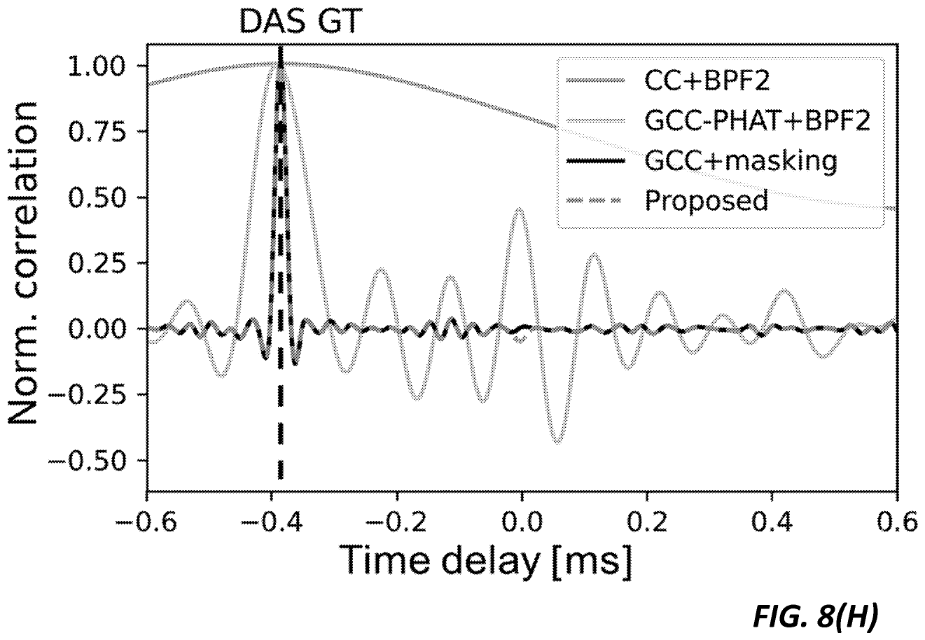

FIG. 8(A)-FIG. 8(H) shows more events detected and localized by our system. FIG. 8(A)-(D), a pole was struck with a wooden rod, generating a moderate impact signal. Due to the strong background noise from laser phase noise and environmental vibrations, the event is not immediately apparent on raw the spectrogram. However, after applying our processing method, we successfully localize the event aligning with the DAS ground truth.

For weak signals such as footsteps on a handhole lid (FIG. 8(E)-(F)), detection using conventional forwarding-transmission method is challenging, as the signal amplitude is less than 10 rad. Nonetheless, our method effectively identifies and localize with event, albeit with a wider correlation width. It is noted that defining the real-world localization accuracy in forwarding-transmission method is challenging without prior knowledge of the signal characteristics, since the accuracy is inversely proportional to the signal bandwidth above noise level. Thus, for unknown, weak signals such as footsteps, fewer t-f points remain after the adaptive masking, leading to reduced localization accuracy. This is different from the DAS where spatial resolution is predefined by the pulse width. For a comparison in FIG. 8(G)-(H), we detected and localized a cable-hitting event in a handhole, producing a large signal amplitude around 1500 rad. In this case, all localization algorithms accurately pinpoint the event's location, with our method demonstrating the narrowest peak, highlighting its superior performance.

At this point, those skilled in the art will understand that while we have presented our inventive concepts and description using specific examples, our invention is not so limited. Accordingly, the scope of our invention should be considered in view of the following claims.

1. A system for high-sensitivity forward-transmission vibration sensing, comprising:
a laser source configured to generate an optical signal;
a transmitter configured to launch counter-propagating probe signals through at least two fibers in a common cable;
a receiver comprising at least one coherent receiver configured to detect the probe signals; and
a processor configured to:
transform detected phase signals into a time-frequency domain;
apply an adaptive time-frequency mask to identify a vibration event by suppressing common phase noise; and
localize the vibration event using in-band laser phase noise suppression via a detuning matrix.

2. The system of claim 1, wherein the adaptive time-frequency mask is generated by subtracting time-frequency representations of the counter-propagating signals.

3. The system of claim 1, wherein the in-band laser phase noise suppression is configured to balance a correlation term with a detuning term to eliminate biased correlation peaks.

4. The system of claim 1, wherein the vibration event has a signal amplitude as low as 10 rad.
